(19) United States
(12) Patent Application Publication
(10) Pub. No.: US 2011/0259498 A1
(43) Pub. Date: Oct. 27, 2011

(54) PNEUMATIC TIRE, THE CROWN REGION OF WHICH IS PROVIDED WITH A SUBLAYER THAT REDUCES ROLLING NOISE

(75) Inventors: Salvatore Pagano, Tokyo (JP); Mitsue Tanaka, Gunma (JP)

(73) Assignees: Michelin Recherche et Technique S.A., Granges-Paccot (CH); Societe De Technologie Michelin, Clermont-Ferrand (FR)

(21) Appl. No.: 13/132,349

(22) PCT Filed: Dec. 10, 2009
(86) PCT No.: PCT/EP2009/008832

§ 371 Date: Jul. 14, 2011

(30) Foreign Application Priority Data
Dec. 17, 2008 (FR) 0858716

(51) Int. Cl. B60C 19/00; C08L 9/00; B60C 5/00

(52) U.S. Cl. 152/450; 524/571

(57) ABSTRACT

Radial tire for motor vehicle, comprising:
a crown comprising a tread provided with at least one radially outer part intended to come into contact with the road;
two beads, two sidewalls connecting the beads to the tread, a carcass reinforcement passing into the two sidewalls and anchored in the beads;
the crown being reinforced by a crown reinforcement or belt placed circumferentially between the carcass reinforcement and the tread;
a radially inner elastomer layer known as a “sublayer”, having a formulation different from the formulation of the radially outer elastomer layer, this sublayer being placed between the radially outer layer of the tread and the belt,
   wherein said sublayer comprises at least one diene elastomer and, as a high-density filler, more than 50 phr of particles having a density of greater than 4 g/cm³. This sublayer of specific formulation has the ability to reduce the rolling noise emitted by the tire without compromising its usage properties.

The invention relates to tyres for motor vehicles and also to rubbery compositions that can be used for the manufacture of such tyres.

It relates more particularly to the rubbery compositions used in the crown of tyres having a radial carcass reinforcement for reducing the noise emitted when these tyres are rolling.

It is known that the noise emitted by a tyre when rolling originates, inter alia, from the vibrations of its structure following contact of the tyre with the uneven roadway, also giving rise to a generation of various sound waves. This is all ultimately manifested in the form of noise, both inside and outside the vehicle. The amplitude of these various manifestations is dependent on the modes of vibration characteristic of the tyre but also on the nature of the surface on which the vehicle is moving. The range of frequencies corresponding to the noise generated by the tyres typically extends from 20 to 4000 Hz approximately.

As regards the noise detected inside the vehicle, two modes of sound propagation coexist:
the vibrations are transmitted by the wheel centre, the suspension system and the transmission ultimately generating noise in the passenger compartment; this is then referred to as solid-borne transmission, which is generally dominant for the low frequencies of the spectrum (up to approximately 400 Hz);
the sound waves emitted by the tyre are directly propagated by an airborne route inside the vehicle, the latter serving as a filter; this is then referred to as airborne transmission, which generally dominates in the high frequencies (approximately 600 Hz and above).

The noise referred to as “road noise” refers rather to the overall level detected in the vehicle and in a frequency range extending up to 2000 Hz. The noise referred to as “cavity noise” refers to the disturbance due to the resonance of the inflation cavity of the tyre cover.

As regards the noise emitted outside the vehicle, the various interactions between the tyre and the road surface, and the tyre and the air are relevant, which will give rise to a disturbance for local residents when the vehicle is running along a roadway. In this case several sources of noise are also distinguished such as the noise referred to as “indentation noise” due to the impact of the roughness of the road in the contact area, the noise referred to as “friction noise” essentially generated at the end of the contact area, the noise referred to as “tread pattern noise” due to the arrangement of the tread pattern elements and to the resonance in the various grooves. The range of frequencies in question here typically corresponds to a range extending from 300 to 3000 Hz approximately.

However, the Applicants have discovered, during their research, a specific rubber composition that, incorporated into the internal structure of the tyres, has improved sound-barrier properties within a frequency range lying between 500 and 2000 Hz, and which is therefore capable of helping to reduce the noises emitted both inside and outside vehicles when their tyres are rolling.

Consequently, a first subject of the invention relates to a radial tyre for a motor vehicle, comprising:
a crown comprising a tread provided with at least one radially outer part intended to come into contact with the road;
two beads, two sidewalls connecting the beads to the tread, a carcass reinforcement passing into the two sidewalls and anchored in the beads;
the crown being reinforced by a crown reinforcement or belt placed circumferentially between the carcass reinforcement and the tread;
a radially inner elastomer layer known as a “sublayer”, having a formulation different from the formulation of the radially outer elastomer layer, this sublayer being placed between the radially outer layer of the tread and the belt,
   and being characterized in that said sublayer comprises at least one diene elastomer, and, as a high-density filler, more than 50 phr of particles having a density of greater than 4 g/cm³.

According to a first preferred embodiment of the invention, this noise-reducing elastomer sublayer is internal to the tread, constituting the part commonly known as the “base” of a tread of “cap-base” construction. In this case, the sublayer or base is of course an unpatterned part, that is to say that it is not intended to come into contact with the road when the tyre is running, unlike the radially outer part intended to come into contact with the road and that is therefore, by definition, patterned.

According to another preferred embodiment of the invention, the noise-reducing sublayer is external to (i.e., is not a part of) the tread, placed between the tread and the belt.

In any case and irrespective of the preferred embodiment of the invention, the sublayer is therefore an internal part of the tyre of the invention, which is not visible from the outside of said tyre, in other words which is not in contact with air or an inflation gas.

The tyres of the invention are particularly intended to be fitted on motor vehicles of the passenger type, including 4×4 (four-wheel drive) vehicles and SUV vehicles (“Sport Utility Vehicles”), two-wheel vehicles (especially motorcycles), for instance industrial vehicles chosen in particular from vans and heavy vehicles (i.e. underground trains, buses, heavy road transport vehicles such as lorries, towing vehicles and trailers, off-road vehicles such as agricultural or civil-engineering vehicles).

The invention relates to the above tyres both in the uncured state (i.e. before curing) and in the cured state (i.e. after crosslinking or vulcanization).

The invention also relates to the use as a noise-reducing layer, in a tyre, of an elastomer sublayer, the formulation of which is as defined above.

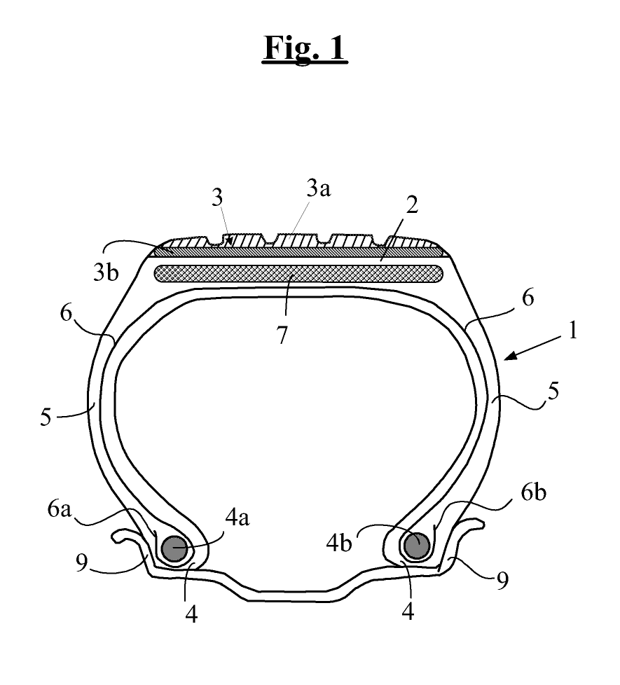

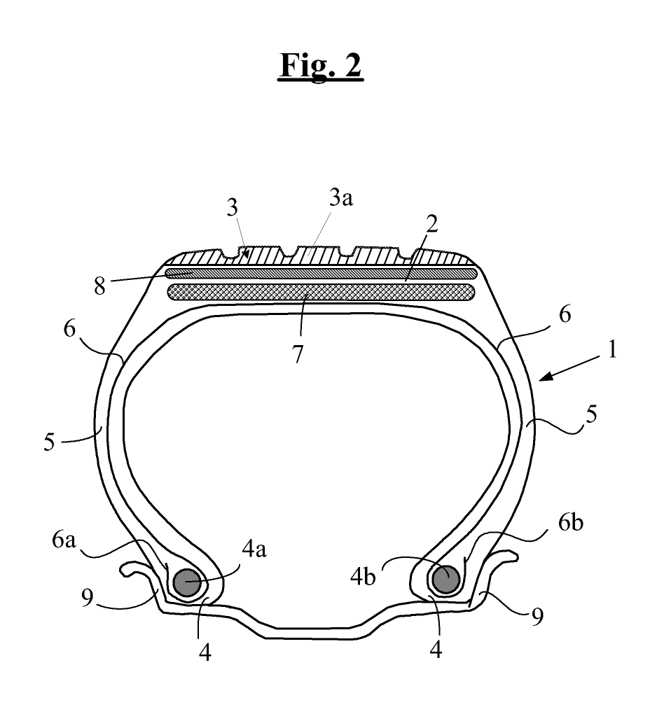

The invention and its advantages will be readily understood in light of the description and exemplary embodiments that follow, and also FIGS. 1 and 2 relating to these embodiments which schematically show, in radial cross section, two examples of radial tyres in accordance with the invention.

### I—DEFINITIONS

In the present application, the following definitions are understood, in a known manner:
“axial”: a direction parallel to the axis of rotation of the tyre; this direction may be “axially interior” when it is oriented towards the inside of the tyre and “axially exterior” when it is oriented towards the outside of the tyre;
“bead”: the essentially inextensible portion of the tyre internally radially adjacent to the sidewall and the base of which is intended to be mounted on a rim seat of a vehicle wheel;
“diene elastomer (or rubber)”: an elastomer resulting at least in part (i.e. a homopolymer or a copolymer) from diene monomer(s) (i.e. monomer(s) bearing two carbon-carbon double bonds which may or may not be conjugated);
“sidewall”: the portion of the tyre, usually of low flexural stiffness, located between the crown and the bead;
“secant modulus in extension” (denoted by E10): the tensile modulus measured in a second elongation (i.e. after an accommodation cycle) at 10% elongation (according to ASTM D412 1998; test specimen “C”), this modulus being the “true” secant modulus, i.e. the modulus relative to the actual cross section of the test specimen (standard temperature and relative humidity conditions according to the ASTM D 1349 (1999) standard);
“phr”: signifies parts by weight per hundred parts of elastomer or rubber (of the total of the elastomers if several elastomers are present);
“radial”: a direction that passes through the axis of rotation of the tyre and normal to the latter; this direction may be “radially internal (or inner)” or “radially external (or outer)” depending on whether it is oriented towards the axis of rotation of the tyre or towards the outside of the tyre;
“reinforcement” or “reinforcing element”: both of monofilaments and of multifilaments, or of assemblies such as cords, folded yarns or else any type of equivalent assembly, irrespective of the material and the treatment of these reinforcements, for example surface treatment or coating such as rubber coating, or else presizing to promote adhesion to the rubber;
“circumferentially oriented reinforcement” or “circumferential reinforcement”: a reinforcement oriented substantially parallel to the circumferential direction of the tyre, that is to say making, with this direction, an angle that does not deviate by more than five degrees from the circumferential direction;
“radially oriented reinforcement” or “radial reinforcement”: a reinforcement contained substantially within one and the same axial plane or in a plane that makes, with an axial plane, an angle of less than or equal to 10 degrees.

Moreover, in the present description and unless expressly indicated otherwise, all the percentages (%) indicated are % by weight; similarly, any interval of values denoted by the expression “between a and b” represents the range of values of greater than “a” and of less than “b” (i.e. the limits a and b excluded) whereas any interval of values denoted by the expression “from a to b” means the range of values going from “a” to “b” (i.e. including the strict limits a and b).

### II—DETAILED DESCRIPTION OF THE INVENTION

The tyre of the invention therefore has the essential feature of being provided with a noise-reducing sublayer or base comprising a rubber composition which comprises at least one diene elastomer, as a high-density filler more than 50 phr of particles having a density of greater than 4 g/cm³, optionally a reinforcing filler and other optional additives that will be described in detail below.

### II-1.—Formulation of the Elastomer Sublayer

### II-1-A. Diene Elastomer

Diene elastomers may be classified, in a known manner, into two categories: those said to be “essentially unsaturated” and those said to be “essentially saturated”. For example, butyl rubbers or diene/α-olefin copolymers of the EPDM type fall under the category of essentially saturated diene elastomers, having a low or very low content of units of diene origin, always less than 15% (mol %). A contrario, the expression “essentially unsaturated diene elastomer” is understood to mean a diene elastomer resulting at least partly from conjugated diene monomers, having a content of units of diene origin (conjugated dienes) that is greater than 15% (mol %). In the “essentially unsaturated” diene elastomer category, the expression “highly unsaturated diene elastomer” is understood in particular to mean a diene elastomer having a content of units of diene origin (conjugated dienes) that is greater than 50%.

It is preferred to use at least one diene elastomer of the highly unsaturated type, in particular a diene elastomer chosen from the group consisting of polybutadienes (BRs) (especially those having a content of cis-1,4-bonds of greater than 90%), synthetic polyisoprenes (IRs), natural rubber (NR), butadiene copolymers, isoprene copolymers (other than IIR) and mixtures of these elastomers. Such copolymers are more preferably chosen from the group consisting of butadiene/styrene copolymers (SBRs), isoprene/butadiene copolymers (BIRs), isoprene/styrene copolymers (SIRs), isoprene/butadiene/styrene copolymers (SBIRs) and mixtures of such copolymers.

The elastomers can, for example, be block, random, sequential or microsequential elastomers and can be prepared in dispersion or in solution; they can be coupled and/or star-branched or else functionalized with a coupling and/or star-branching or functionalizing agent. For coupling with carbon black, mention may be made, for example, of functional groups comprising a C—Sn bond or of aminated functional groups, such as benzophenone, for example; for coupling with a reinforcing inorganic filler such as silica, mention may be made, for example, of silanol functional groups or polysiloxane functional groups having a silanol end (as described, for example, in U.S. Pat. No. 6,013,718), of alkoxysilane groups (as described, for example, in U.S. Pat. No. 5,977,238), of carboxylic groups (as described, for example, in U.S. Pat. No. 6,815,473 or US 2006/0089445) or else of polyether groups (as described, for example, in U.S. Pat. No. 6,503,973). Mention may also be made, as other examples of functionalized elastomers, of the elastomers (such as SBR, BR, NR or IR) of the epoxidized type.

According to one particularly preferred embodiment of the invention, the diene elastomer is chosen from the group consisting of natural rubber, synthetic polyisoprenes, polybutadienes having a content of cis-1,4-bonds of greater than 90%, butadiene/styrene copolymers and mixtures of these elastomers.

The following are preferably suitable: polybutadienes and in particular those having a content of 1,2-units of between 4% and 80% or those having a content of cis-1,4-units of greater than 80%, polyisoprenes, butadiene/styrene copolymers and in particular those having a styrene content of between 5% and 50% by weight and more particularly between 20% and 40%, a content of 1,2-bonds of the butadiene part of between 4% and 65% and a content of trans-1,4-bonds of between 20% and 80%, butadiene/isoprene copolymers and in particular those having an isoprene content of between 5% and 90% by weight and a glass transition temperature (“T_{g}”, measured according to ASTM D3418-82) from −80° C. to −40° C., or isoprene/styrene copolymers and in particular those having a styrene content of between 5% and 50% by weight and a T_{g} of between −50° C. and −10° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2-units of the butadiene part of between 4% and 85%, a content of trans-1,4-units of the butadiene part of between 6% and 80%, a content of 1,2- plus 3,4-units of the isoprene part of between 5% and 70% and a content of trans-1,4-units of the isoprene part of between 10% and 50%, and more generally any butadiene/styrene/isoprene copolymer having a T_{g} of between −20° C. and −70° C., are suitable in particular.

According to one particular and preferred embodiment of the invention, the elastomer sublayer comprises, as diene elastomer, at least 40 phr, more preferably at least 50 phr (as a reminder, “phr” stands for parts by weight per hundred parts of elastomer) of natural rubber or synthetic polyisoprene, the latter possibly being combined, or not, with a second diene elastomer, in particular an SBR copolymer (solution or emulsion SBR) or a polybutadiene having a content of cis-1,4-bonds which is preferably greater than 90%.

According to another more particular and preferred embodiment, the sublayer comprises, as diene elastomer, from 40 to 80 phr (more preferably from 50 to 80 phr) of natural rubber or synthetic polyisoprene, with 20 to 60 phr (preferably 20 to 50 phr) of an SBR copolymer or of a polybutadiene having a content of cis-1,4-bonds which is preferably greater than 90%, more preferably still greater than 95%.

According to another particular and preferred embodiment of the invention, the sublayer comprises, as diene elastomer, at least 40 phr, more preferably at least 50 phr, of a polybutadiene (BR) having a content of cis-1,4-bonds which is greater than 90%, more preferably still greater than 95%. More preferably, said polybutadiene is then used as a blend with natural rubber or a synthetic polyisoprene.

According to another particular and preferred embodiment, the diene elastomer used is a ternary blend (mixture) of NR (or IR), BR and SBR. Preferably, in the case of such blends, the composition comprises from 40 to 80 phr of NR (or IR) and from 20 to 60 phr of BR and SBR.

Synthetic elastomers other than diene elastomers, or even polymers other than elastomers, for example thermoplastic polymers, may be combined, in a minority amount, with the diene elastomers of the treads according to the invention.

### II-1-B. High-Density Filler

The elastomer sublayer of the tyre of the invention has the essential feature of comprising more than 50 phr, preferably between 50 and 600 phr, of a high-density filler, of which the density of the particles is greater than 4 g/cm³, preferably greater than 4.5 g/cm³, more preferably still greater than 5 g/cm³.

Such high-density fillers are well known to a person skilled in the art of tyres. They have essentially been used to date in tyre treads as a replacement for or in addition to conventional less dense fillers such as silica or carbon black, to attempt to improve some of their usage properties or compromise of properties such as, for example, rolling resistance, wear resistance or grip (see in particular U.S. Pat. No. 6,734,245 and U.S. Pat. No. 6,838,495).

The high-density filler used may be in the form of isometric or anisometric particles. It is preferably of micrometre size, i.e. it is in the form of “microparticles”, the size of which is, by definition, greater than one micrometre. Preferably, these microparticles have a median diameter (or a median size if the particles are not essentially spherical), denoted hereinafter by “D”, which is between 1 and 500 μm; more preferably, the median diameter D of the particles is between 2 and 400 μm, in particular between 2 and 200 μm.

The high-density filler is preferably in powder form. According to another preferred embodiment (whether it is in powder form or not), it is in the form of solid particles, but hollow particles or beads of high density could also be used.

The content of high-density filler is more preferably between 50 and 500 phr. Below the indicated minimum, the targeted technical effect is insufficient, whereas above the recommended maximum, there is a risk of encountering problems of increase in the modulus, of embrittlement of the composition and also filler dispersion and processability difficulties, not to mention a significant degradation of the hysteresis. For all these reasons, this content is more particularly within a range from 70 to 400 phr, most particularly within a range from 90 to 350 phr.

The high-density filler is preferably metallic (i.e., based on metal or on a metal derivative); it preferably consists of metals such as alkaline-earth metals, transition metals or rare-earth metals, or else derivatives of such metals such as, for example sulphates, carbonates, sulphides, oxides and/or hydroxides, particularly oxides of such metals.

In the case of alkaline-earth metals, mention will be made in particular of barium and strontium. In the case of transition metals, mention will be made in particular of iron, copper, tin, zinc, molybdenum, silver, niobium, tungsten, rhenium, tantalum, hafnium, bismuth, and manganese. Finally, in the case of rare-earth metals, mention will be made in particular of lanthanum, neodymium, cerium or samarium.

More preferably, the metal of the high-density filler, whether it is in the form of a metal or a metal derivative such as an oxide, is chosen from the group consisting of iron, copper, tin, zinc, tungsten, bismuth, cerium, neodymium and mixtures of these metals.

These metals and/or metal derivatives, particularly metal oxides, are preferably chosen from those for which the density is greater than 5 g/cm³. As examples of particularly preferred metal oxides, mention may especially be made of those chosen from the group consisting of Fe₂O₃ (density 5.1 g/cm³), ZnO (5.7 g/cm³), CuO (6.3 g/cm³), SnO₂ (7.0 g/cm³), WO₃ (7.2 g/cm³), CeO₂ (7.3 g/cm³), Nd₂O₃ (7.2 g/cm³), Bi₂O₃ (8.9 g/cm³) and mixtures of such oxides.

These metal oxides are well known and are available commercially, for example from Nakalai Tesque Inc., Toho Zinc Co., Nihon Kagaku Sangyo Co., Kanto Kagaku, Taiyo Koko Co. and American Elements.

The high-density filler may be introduced into the elastomer composition according to various known processes, for example by compounding in solution, by bulk compounding in an internal mixer, or else by compounding via extrusion.

For the particle size analysis and the calculation of the median diameter of the particles, in particular microparticles, of the high-density filler, various known methods can be applied, for example via laser scattering (for example according to ISO-8130-13 standard or JIS K5600-9-3 standard); it is also possible to simply use a particle size analysis via a mechanical screening through screens of different diameters. The median diameter (or median size) is ultimately calculated in a known manner from the histogram of the particle size distribution.

### II-1-C. Reinforcing Filler

The elastomer sublayer may also comprise a filler referred to as a reinforcing filler, known for its ability to reinforce a rubber composition that can be used for the manufacture of tyres, for example an organic filler, such as carbon black or else a reinforcing inorganic filler, such as silica with which a coupling agent is, in a known manner, combined.

As is well known to a person skilled in the art, such a reinforcing filler preferably consists of nanoparticles, the average (weight-average) size of which is less than 1 micrometre, generally less than 500 nm, usually between 20 and 200 nm, in particular and more preferably between 20 and 150 nm.

The density of this reinforcing filler is generally less than 3 g/cm³, in particular less than 2.5 g/cm³.

Preferably, the content of total reinforcing filler (in particular silica or carbon black or a mixture of silica and carbon black) is between 0 and 100 phr. Above 100 phr there is a risk of increasing the hysteresis and therefore the rolling resistance of the tyres. For this reason, the content of total reinforcing filler is more preferably between 2 and 50 phr.

All carbon blacks conventionally used in tyres or their treads (“tyre-grade” blacks) are suitable as carbon blacks. Mention will more particularly be made, among the latter, of the reinforcing carbon blacks of the 100, 200 or 300 series, or of the blacks of the 500, 600 or 700 series (ASTM grades), such as, for example, the N115, N134, N234, N326, N330, N339, N347, N375, N550, N683 or N772 blacks. The carbon blacks could, for example, already be incorporated in the diene, especially isoprene, elastomer in the form of a masterbatch (see, for example, Applications WO 97/36724 or WO 99/16600).

Mention may be made, as examples of organic fillers other than carbon blacks, of the functionalized polyvinyl organic fillers as described in Applications WO-A-2006/069792, WO-A-2006/069793, WO-A-2008/003434 and WO-A-2008/003435.

The expression “reinforcing inorganic filler” should be understood here to mean any inorganic or mineral filler, whatever its colour and its (natural or synthetic) origin, also known as “white filler”, “clear filler” or sometimes “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known manner, by the presence of hydroxyl (—OH) groups at its surface.

Mineral fillers of the siliceous type, in particular silica (SiO₂), are suitable in particular as reinforcing inorganic fillers. The silica used may be any reinforcing silica known to a person skilled in the art, in particular any precipitated or pyrogenic silica having a BET surface area and a CTAB specific surface area that are both less than 450 m²/g, preferably from 30 to 400 m²/g, in particular between 60 and 300 m²/g. Mention will be made, as highly dispersible precipitated silicas (“HDSs”), for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG and the Zeopol 8715, 8745 and 8755 silicas from Huber.

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is especially made of polysulphide-containing silanes, referred to as “symmetrical” or “asymmetrical” depending on their particular structure, as described, for example, in Applications WO 03/002648 (or US 2005/016651) and WO 03/002649 (or US 2005/016650).

Particularly suitable, without the definition below being limiting, are polysulphide-containing silanes corresponding to the following general formula (I):

Z-A-Sₓ-A-Z, in which: (I)
x is an integer from 2 to 8 (preferably from 2 to 5);
the A symbols, which are identical or different, represent a divalent hydrocarbon radical (preferably, a C₁-C₁₈ alkylene group or a C₆-C₁₂ arylene group, more particularly a C₁-C₁₀, especially C₁-C₄, alkylene, in particular propylene);
the Z symbols, which are identical or different, correspond to one of the three formulae below:

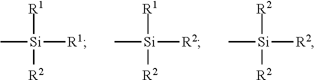

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, especially C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

In the case of a mixture of polysulphide-containing alkoxysilanes corresponding to formula (I) above, especially standard commercially-available mixtures, the average value of “x” is a fractional number preferably between 2 and 5, more preferably close to 4. But the invention may also be advantageously carried out, for example, with disulphide-containing alkoxysilanes (x=2).

Mention will more particularly be made, as examples of polysulphide-containing silanes, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) polysulphides or bis(3-triethoxysilylpropyl) polysulphides. Use is in particular made, among these compounds, of bis(3-triethoxysilylpropyl) tetrasulphide, abbreviated to TESPT, of formula [(C₂H_{S}O)₃Si(CH₂)₃S₂]₂ or bis(triethoxysilylpropyl) disulphide, abbreviated to TESPD, of formula [(C₂H_{S}O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilyl-propyl) tetrasulphide, as described in the aforementioned Patent Application WO 02/083782 (or U.S. Pat. No. 7,217,751).

Mention will especially be made, as examples of coupling agents other than a polysulphide-containing alkoxysilane, of bifunctional POSs (polyorganosiloxanes) or else of hydroxysilane polysulphides (R²═OH in formula I above), such as described, for example, in Patent Applications WO 02/30939 (or U.S. Pat. No. 6,774,255) and WO 02/31041 (or US 2004/051210) and WO 2007/061550, or else of silanes or POSs bearing azodicarbonyl functional groups, such as described, for example, in Patent Applications WO 2006/125532, WO 2006/125533 or WO 2006/125534.

As examples of other sulphide-containing silanes, mention will be made, for example, of the silanes bearing at least one thiol (—SH) function (referred to as mercaptosilanes) and/or at least one blocked thiol function, such as described, for example, in Patents or Patent Applications U.S. Pat. No. 6,849,754, WO 99/09036, WO 2006/023815 or WO 2007/098080.

Of course, use could also be made of mixtures of the coupling agents described previously, as described in particular in the aforementioned Application WO 2006/125534.

In the noise-reducing sublayer, when it is reinforced by an inorganic filler such as silica, the content of coupling agent is preferably between 2 and 15 phr, more preferably between 3 and 12 phr.

A person skilled in the art will understand that, as equivalent filler to the reinforcing inorganic filler described in the present section, a reinforcing filler of another nature, in particular organic nature, could be used provided that this reinforcing filler is covered with an inorganic layer, such as silica, or else comprises functional sites, in particular hydroxyl sites, at its surface that require the use of a coupling agent in order to form the bond between the filler and the elastomer.

### II-1-D. Various Additives

The elastomer composition of the noise-reducing sublayer may also comprise all or some of the usual additives customarily used in the rubber compositions for tyres, especially those intended for the manufacture of tread bases of cap-base construction, such as, for example, protective agents such as chemical antiozonants, antioxidants, plasticizing agents or extender oils, whether the latter are of aromatic or non-aromatic nature, in particular non-aromatic or very weakly aromatic oils, for example of naphthenic or paraffinic type, having a high viscosity or preferably having a low viscosity, MES oils, TDAE oils, plant oils, fillers other than those mentioned previously, for example platy fillers (e.g. phyllosilicates such as kaolin, talc, mica, graphite, clays or modified clays (organoclays)) capable of further improving the barrier effect, hydrocarbon plasticizing resins with a high T_{g} (preferably above 30° C.), tackifying resins, reinforcing resins, methylene acceptors or methylene donors, a crosslinking system based either on sulphur or on sulphur donors and/or on peroxide and/or on bismaleimides, vulcanization accelerators and vulcanization activators.

The elastomer composition of the sublayer may also contain coupling activators when a coupling agent is used, agents for covering the inorganic filler when an inorganic filler is used, or more generally processing aids capable, in a known manner, owing to an improvement of the dispersion of the filler in the rubber matrix and to a lowering of the viscosity of the compositions, of improving their ability to be processed in the uncured state; these agents are, for example, hydrolysable silanes or hydroxysilanes such as alkylalkoxysilanes, polyols, polyethers, amines or hydroxylated or hydrolysable polyorganosiloxanes.

### II-2.—Manufacture of the Compositions

The rubber compositions forming the sublayer are manufactured in appropriate mixers using, for example, two successive preparation phases according to a general procedure well known to a person skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at a lower temperature, typically below 120° C., for example between 60° C. and 100° C., finishing phase during which the crosslinking or vulcanization system is incorporated.

A process that can be used for the manufacture of such rubber compositions comprises, for example, and preferably, the following stages:
in a mixer, incorporating into the diene elastomer or into the mixture of diene elastomers, the high-density filler and the optional other reinforcing filler, everything being kneaded thermomechanically, in one or more steps, until a maximum temperature of between 130° C. and 200° C. is reached;
cooling the combined mixture to a temperature below 100° C.;
subsequently incorporating a crosslinking system;
kneading everything up to a maximum temperature below 120° C.;
extruding or calendering the rubber composition thus obtained.

By way of example, the first (non-productive) phase is carried out in a single thermomechanical stage during which all the necessary constituents, the optional additional covering agents or processing aids, and other various additives, with the exception of the crosslinking system, are introduced into an appropriate mixer, such as a standard internal mixer. After cooling the mixture thus obtained during the first non-productive phase, the crosslinking system is then incorporated, at low temperature, generally in an external mixer, such as an open mill. The combined mixture is then mixed (productive phase) for a few minutes, for example between 5 and 15 min.

The crosslinking system itself is preferably based on sulphur and on a primary vulcanization accelerator, in particular an accelerator of the sulphenamide type. Added to this vulcanization system are various known secondary accelerators or vulcanization activators, such as zinc oxide, stearic acid, guanidine derivatives (in particular diphenylguanidine), etc., incorporated during the first non-productive phase and/or during the productive phase. The sulphur content is preferably between 0.5 and 5 phr and the primary accelerator content is preferably between 0.5 and 8 phr.

Use may be made, as (primary or secondary) accelerator, of any compound capable of acting as accelerator of the vulcanization of diene elastomers in the presence of sulphur, in particular accelerators of the thiazole type and also their derivatives, accelerators of the thiuram and zinc dithiocarbamate types. These accelerators are more preferably chosen from the group formed by 2-mercaptobenzothiazyl disulphide (abbreviated to “MBTS”), N-cyclohexyl-2-benzothiazyl sulphenamide (abbreviated to “CBS”), N,N-dicyclohexyl-2-benzothiazyl sulphenamide (“DCBS”), N-tert-butyl-2-benzothiazyl sulphenamide (“TBBS”), N-tert-butyl-2-benzothiazyl sulphenimide (“TBSI”), zinc dibenzyldithiocarbamate (“ZBEC”) and the mixtures of these compounds.

The final composition thus obtained is then calendered, for example in the form of a sheet or a slab, in particular for laboratory characterization, or else is extruded in the form of a rubber profiled element that can be used directly as an “anti-noise” elastomer sublayer, for example as the “base” part of a tread.

The vulcanization (or curing) is carried out, in a known manner, at a temperature generally between 130° C. and 200° C., for a sufficient time that may vary, for example, between 5 and 90 min depending in particular on the curing temperature, on the vulcanization system used and on the vulcanization kinetics of the composition in question.

Preferably, the sublayer has, in the vulcanized state (i.e. after curing), a density that is greater than 1.4 g/cm³, in particular between 1.5 and 3.0 g/cm³. Its secant modulus in extension (E10) is preferably less than 30 MPa, more preferably between 3 and 30 MPa, in particular within a range from 4 to 20 MPa.

### II-3.—Tyre of the Invention

The rubber composition described previously is therefore used, in the tyre of the invention, as a noise-reducing elastomer sublayer placed circumferentially on the inside of the crown of the tyre, between, on the one hand, the radially outermost part of its tread, that is to say the portion intended to come into contact with the road when rolling, and, on the other hand, the belt that reinforces said crown.

It should therefore be understood that this sublayer is placed:
either under the tread (i.e. radially internally relative to this tread), between the tread and the belt;
or in the tread itself, but in this case under the portion (i.e. radially internally relative to this portion) of tread which is intended to come into contact with the road when the tyre is rolling, throughout the service life of the latter.

In both cases it is therefore immediately understood that the sublayer described here is, by definition, an internal part of the tyre of the invention, located on the very inside of its structure and not intended to come into contact with the road; this sublayer does not give onto the outside of the tyre, i.e. it is not visible from the outside of said tyre (not in contact with air or an inflation gas), both in the new state and in the worn state.

It may also be recalled that, in the second case, the tread is commonly referred by a person skilled in the art as a tread of “cap-base” construction; the term “cap” denotes the patterned portion of the tread intended to come into contact with the road and the term “base” denotes the unpatterned portion of the tread, of different formulation, which is not intended to come into contact with the road.

Treads of cap-base construction, the base of which has been specifically formulated to reduce the noise emitted by the tyres, by incorporation of foamed rubber or of a specific volume of hollow fillers such as hollow glass beads, have for example been described in patent documents U.S. Pat. No. 5,417,267, U.S. Pat. No. 6,216,757 and U.S. Pat. No. 6,626,216.

In the tyre according to the invention, the thickness of the sublayer is preferably between 0.5 and 5 mm, in particular in a range from 1 to 3 mm.

The appended FIGS. 1 and 2 very schematically (in particular not to a specific scale) represent, in radial cross section, two preferred examples of motor vehicle pneumatic tyres having radial carcass reinforcement, in accordance with the invention.

FIG. 1 illustrates a first possible embodiment of the invention, according to which the noise-reducing elastomer sublayer (3b) is integrated into the tread (3) itself, and placed radially under the portion (3a) of the tread (3) which is intended to come into contact with the road during rolling.

In this FIG. 1, the pneumatic tyre (1) shown schematically comprises a crown region (2) comprising a tread (3) (for simplicity, comprising a very simple tread pattern), the radially outer part (3a) of which is intended to come into contact with the road, two inextensible beads (4) in which a carcass reinforcement (6) is anchored. The crown (2), joined to said beads (4) by two sidewalls (5), is, in a manner known per se, reinforced by a crown reinforcement or “belt” (7) which is at least partly metallic and radially external with respect to the carcass reinforcement (6) passing through this crown region (2), this belt (7) being formed for example from at least two superposed crossed plies reinforced by metal cords.

The carcass reinforcement (6) is here anchored into each bead (4) by winding around two bead wires (4a, 4b), the turn-up (6a, 6b) of this reinforcement (6) being for example positioned towards the outside of the tyre (1), which is shown here mounted on its rim (9).

The carcass reinforcement (6) is formed from at least one ply reinforced by radial textile cords, that is to say these cords are placed practically parallel to one another and extend from one bead to the other so as to form an angle of between 80° and 90° with the median circumferential plane (plane perpendicular to the axis of rotation of the tyre which is located half way between the two beads 4 and passes through the middle of the crown reinforcement 7). Of course, this tyre (1) additionally comprises, in a known manner, an inner elastomer or rubber layer (commonly referred to as “inner liner”) that defines the radially inner face of the tyre and that is intended to protect the carcass ply from the diffusion of air coming from the space inside the tyre.

This tyre (1) in accordance with the invention is characterized in that the base part (3b) of its tread (3) is formed by the sublayer that has been described in detail above.

FIG. 2 illustrates another possible embodiment of the invention, according to which the noise-reducing sublayer (8) is external to the tread (i.e. different from the latter), this time placed in the crown (2) below the tread (i.e. radially internal relative to the latter) and above the belt (i.e. radially external relative to the latter), in other words between the tread (3) and the belt (7).

In the above two schematically represented cases, the elastomer sublayer gives the tyres of the invention improved sound-barrier properties, as is demonstrated in the following running tests of the tyres.

### II-4.—Running Tests

For the requirements of this test, a rubber composition (denoted herein below by C-1) was prepared, the formulation of which is given in Table 1, the content of the various products being expressed in phr (part by weight per hundred parts of total elastomer, here composed of 60 phr of NR and 40 phr of BR).

The manufacture of this composition was carried out in the following manner: the reinforcing filler (carbon black), the high-density filler (CuO microparticles), the diene elastomer (NR and BR) and also the various other ingredients, with the exception of the vulcanization system, were successively introduced into an internal mixer, the initial vessel temperature of which was around 60° C.; the mixer was thus filled to around 70% (% by volume). Thermomechanical working (non-productive phase) was then carried out in one stage of around 2 to 4 min, until a maximum “dropping” temperature of 165° C. was reached. The mixture thus obtained was recovered and cooled and then sulphur and an accelerator of sulphenamide type were incorporated in an external mixer (homofinisher) at 30° C., the combined mixture being mixed (productive phase) for a few minutes.

The composition thus obtained, having a density equal to around 1.7 g/cm³, was then calendered in the form of a base (sublayer) of a tread of cap-base type, then the latter was incorporated into a passenger vehicle tyre (dimensions 225/55 R17) as illustrated in FIG. 1.

This tyre (denoted by P-1) in accordance with the invention was compared with a control tyre (denoted hereinbelow by P-2), of identical dimensions and construction, also provided with a tread of cap-base construction, the base of which this time comprised a conventional composition (denoted hereinbelow by C-2, having a density of 1.1 g/cm³), having the same formulation as that of composition C-1 but with no high-density filler (weight of the tyre P-2 300 g less than that of the tyre P-1); moreover, in order to be able to compare the anti-noise effectiveness of the two layers at the same stiffness (that is to say for an identical Shore A hardness), the stiffness of composition C-1 had to be increased by using 50 phr of carbon black (N550).

In order to characterize the two types of tyres and the sound-barrier properties of their respective sublayers, a running test was carried out in which the sound level emitted was evaluated by measuring the sound pressure level near the tyre, when the vehicle was running, owing to microphones positioned at a distance very close to the tyre (method known under the name of “Microphone Near Tyre” or MNT method). More specifically, two microphones, fixed to the chassis of the vehicle, are positioned at a distance of around 20 cm from the tyre, one at the start of the contact area of the tyre with the ground and the other at the end of this contact area.

The vehicle used is a Toyota vehicle (“Celsior”). The surfacing of the road used for this test corresponds to a semi-rough asphalt. The speed of the vehicle is adjusted to 60 km/h and during the passage in the area of measurement, the engine is cut (gearbox put into neutral) then the recording of the sound pressure is started. The control tyre P-2 containing composition C-2 as the sublayer is used here as a reference tyre.

The results from Table 2 express the differences in the recorded sound level between the tyre P-1 in accordance with the invention and the control tyre P-2, in a range of frequencies investigated from 700 to 1900 Hz (in steps of 200 Hz). These differences are expressed as sound energy (dB(A)) which corresponds to the integration of the sound pressure as a function of the frequency over the range of frequencies in question, a negative value indicating a reduction in the noise relative to the reference.

On reading Table 2, it is unexpectedly observed that, irrespective of the particular frequency range investigated between 700 and 1900 Hz, the tyre of the invention always emits less noise than the control tyre, both at the start and at the end of the contact area of the tyre with the roadway, a reduction of 0.8 dB(A) for example being considered as quite significant for a person skilled in the art.

Such a result can of course only be attributed to the specific formulation of the sublayer of the tyre of the invention, particularly to the presence of the high-density filler at the particularly high content that is recommended.

Furthermore, additional running tests demonstrated that the tyres according to the invention P-1 had a high-speed endurance, a rolling resistance and also a cornering thrust which were substantially identical to those of the control tyres. Thus, owing to the invention, it is possible to reduce the noise emitted by the tyres, without compromising their usage properties.

TABLE 1

| Formulation: | phr |
|---|---|
| NR (1) | 60 |
| BR (2) | 40 |
| carbon black (3) | 25 |
| high-density particles (4) | 115 |
| ZnO | 3 |
| stearic acid | 0.5 |
| antioxidant (5) | 2 |
| sulphur | 3 |
| accelerator (6) | 1.5 |

(1) Natural rubber (peptized);
(2) Polybutadiene with 4.3% of 1,2- units; 2.7% of trans units; 97% of cis-1,4- units (T_{g} = −104° C.);
(3) ASTM grade N234 (Cabot);
(4) Microparticles of CuO (known as “ET” from Nippon Kagaku Sangyo);
(5) N-1,3-dimethylbutyl-N-phenyl-para-phenylenediamine (Santoflex 6-PPD from Flexsys);
(6) N-dicyclohexyl-2-benzothiazolsulphenamide (“Santocure CBS” from Flexsys).

TABLE 2

Range (Hz)

| | 700- | 900- | 1100- | 1300- | 1500- | 1700- |
|---|---|---|---|---|---|---|
| | 900 | 1100 | 1300 | 1500 | 1700 | 1900 |
| dB(A) (1) | −0.2 | −0.5 | −0.8 | −0.3 | −0.6 | −0.3 |
| dB(A) (2) | −0.1 | −0.3 | −0.8 | −0.8 | −0.5 | −0.1 |

(1) difference between tyre of the invention and control tyre, at the start of the contact area;
(2) difference between tyre of the invention and control tyre, at the end of the contact area.

1. Radial tire for motor vehicle, comprising:
a crown comprising a tread provided with at least one radially outer intended to come into contact with the road;
two beads, two sidewalls connecting the beads to the tread, a carcass reinforcement passing into the two sidewalls and anchored in the beads;
the crown being reinforced by a crown reinforcement or belt placed circumferentially between the carcass reinforcement and the tread;
a radially inner elastomer layer known as a “sublayer”, having a formulation different from the formulation of the radially outer elastomer layer, this sublayer being placed between the radially outer layer of the tread and the belt,
wherein said sublayer comprises at least one diene elastomer and, as a high-density filler, more than 50 phr of particles having a density of greater than 4 g/cm³.

2. Tire according to claim 1, in which the diene elastomer is chosen from the group consisting of natural rubber, synthetic polyisoprenes, polybutadienes, butadiene copolymers, isoprene copolymers and blends of these elastomers.

3. Tire according to claim 2, in which the sublayer comprises, as diene elastomer, at least 40 phr of natural rubber or synthetic polyisoprene.

4. Tire according to claim 3, in which the natural rubber or synthetic polyisoprene is used as a blend with a second diene elastomer.

5. Tire according to claim 4, in which the second diene elastomer is chosen from the group consisting of polybutadienes, butadiene copolymers and blends of these elastomers.

6. Tire according to claim 4, in which the content of natural rubber or synthetic polyisoprene is within a range from 40 to 80 phr and the content of second diene elastomer is within a range from 20 to 60 phr.

7. Tire according to claim 1, in which the content of high-density particles is between 50 and 600 phr.

8. Tire according to claim 1, in which the density of the particles is greater than 4.5 g/cm³.

9. Tire according to claim 8, in which the density of the particles is greater than 5.0 g/cm³.

10. Tire according to claim 1, in which the particles are microparticles.

11. Tire according to claim 1, in which the particles are particles of metal or of a metal derivative.

12. Tire according to claim 11, in which the metal is chosen from the group consisting of iron, copper, tin, zinc, tungsten, bismuth, cerium, neodymium and mixtures of these metals.

13. Tire according to claim 11, in which the particles are particles of metal oxide.

14. Tire according to claim 13, in which the metal oxide is chosen from Fe₂O₃, ZnO, CuO, SnO₂, WO₃, CeO₂, Nd₂O₃, Bi₂O₃ and mixtures of such oxides.

15. Tire according to claim 1, in which the high-density particles are in the form of powder.

16. Tire according to claim 1, in which the sublayer also comprises a reinforcing filler.

17. Tire according to claim 16, in which the reinforcing filler comprises silica or carbon black or a mixture of silica and carbon black.

18. Tire according to claim 16, in which the content of reinforcing filler in the sublayer is between 0 and 100 phr.

19. Tire according to claim 1, in which the sublayer has, in the vulcanized state, a density that is greater than 1.4 g/cm³.

20. Tire according to claim 19, in which the sublayer has, in the vulcanized state, a density that is between 1.5 and 3.0 g/cm³.

21. Tire according to claim 1, in which the sublayer has a thickness between 0.5 and 5 mm.

22. Tire according to claim 1, in which the sublayer constitutes the base of a tread of cap-base construction.

23. Tire according to claim 1, in which the sublayer is external to the tread, placed between the tread and the belt.

24. A method of producing a noise-reducing layer, in a tire, comprising introducing an elastomer layer as defined in claim 1 to the tire.
